(19) United States
(12) Patent Application Publication
(10) Pub. No.: US 2009/0065556 A1
(43) Pub. Date: Mar. 12, 2009

(54) METHOD TO REDUCE SHRINKAGE DRIVEN DISTORTION WHEN WELDING ON PRESSURE PIPING AND VESSEL MATERIALS

(75) Inventors: Troy Lance Finton, Cupertion, CA (US); Michael Peter Fisher, Dublin, CA (US); Merlln Wayne Goddard, Kennewick, WA (US)

Correspondence Address: NIXON & VANDERHYE P.C., 901 NORTH GLEBE ROAD, 11TH FLOOR, ARLINGTON, VA, 22203, US

(73) Assignee: GE-Hitachi Nucleare Energy Americas LLC, Wilmington, NC (US)

(21) Appl. No.: 11/896,914

(22) Filed: Sep. 6, 2007

(51) Int. Cl. B23K 28/00

(52) U.S. Cl. 228/262.1

(57) ABSTRACT

A welding method is disclosed in which a structural weld overlay is re-oriented from a circumferential orientation to an axial orientation during deposition. The axial welding orientation provides a more favorable condition to prevent weld cracking and shrinkage distortion. The axial welding orientation also allows two or more weld machines to be used simultaneously so that two or more welding arcs can simultaneously deposit filler material or the overlay, thereby reducing the time required to complete the structural weld overlay.

The present invention relates to welding, and more particularly, to a method of reducing cracking and shrinkage driven distortion when welding a structural weld overlay onto a dissimilar metal weld between pressure piping and vessel materials.

### BACKGROUND OF THE INVENTION

Depositing a structural weld overlay (“SWO”) onto a dissimilar metal weld (“DMW”) between piping components or pressure vessels and attachments results in significant shrinkage-driven distortion and can result in cracking. Cracking is often likely in the first layer of weld deposited on top of the base metal of the piping or pressure vessel system and can be extensive, if the filler metal used is not compatible with the existing base metal. Excessive amounts of either distortion or cracking can be cause for rejection upon inspection. If the amount of distortion is too large, the area where the SWO was applied may have to be replaced with completely new material, which is expensive and time consuming to do in an operating nuclear power facility. If the amount or extent of cracking is too large, the SWO would require removal and a new SWO applied. This is also expensive and time consuming to do in an operating nuclear power facility.

Another problem is the historically long time it takes to deposit an SWO in the field. One reason that the application time is so long is related to the cracking that can occur. If cracks are noticed in the first layers, additional layers must be added to the overlay design, on the outside diameter (OD,) to compensate and add structural integrity so the overlay can accommodate requisite design stresses. Also, considering the limitations of the conventional state-of-the-art equipment used to deposit a SWO, typically only one machine can be used at a time to deposit the SWO.

Weld deposits, comprising a SWO, are typically oriented in a circumferential configuration with respect to the piping or pressure vessel system. Some oscillation, depositing filler metal normal to the circumferential orientation, has been employed, but is only used over relatively short distances representing a fraction of the overall SWO width. This circumferential configuration has been observed to impart both axial and circumferential shrinkage in both piping and pressure vessel systems.

In the past, observed cracking has been addressed by an adjustment of welding process parameters. Additionally, observed cracks have been removed and repaired on a local basis by only removing the material containing the crack and repeating the welding to fill the area. Another alternative that has also been applied is to simply remove all of the newly deposited weld metal, where cracks were observed, and repeating the entire welding process until no cracks are observed.

Measures taken to reduce the time required to weld a complete SWO include the introduction of modified equipment that reduces the amount of wait time between weld passes, or the systematic elimination of process steps, such as grinding between passes to remove any detrimental oxidation. None of the welding approaches discussed, however, provides a completely satisfactory result in terms of distortion, cracking elimination or time savings.

### BRIEF DESCRIPTION OF THE INVENTION

The present invention employs a modification to conventional welding practice, whereby the orientation and application of a weld deposit, that forms a structural weld overlay, is re-oriented from a circumferential to an axial orientation during deposition. This re-orientation provides a more favorable condition to prevent weld cracking and shrinkage distortion. The welding method of the present invention allows two or more weld machines to be used simultaneously so that two or more welding arcs could be used to deposit filler metal on the same SWO, reducing the overall time required to complete the SWO. The preventative measures afforded by this method result in an overall improvement in structural soundness, corrosion performance and the number of layers required to form a structural weld overlay (SWO) for use on nuclear piping and pressure vessel systems.

### BRIEF DESCRIPTION OF THE DRAWINGS

FIG. 1(a) shows a circumferential orientation of a weld deposit.

FIG. 1(b) shows an axial orientation of a weld deposit.

FIG. 2 shows a “vertical-up” orientation of a weld with respect to a horizontal weld joint.

FIG. 3 shows multiple weld machines mounted on a single weld track that allows simultaneous weld deposition by both machines.

FIG. 4 shows a weld deposit with a first layer deposited axially and a subsequent layer deposited circumferentially.

FIG. 5(a) shows greater shrinkage distortion in a pipe resulting from circumferentially oriented weld deposits.

FIG. 5(b) shows reduced shrinkage distortion in a pipe observed with axially deposited welds.

FIG. 6(a) shows greater change in a pipe bore observed when welds are deposited circumferentially.

FIG. 6(b) shows reduced change in a pipe bore observed when welds are deposited axially.

### DETAILED DESCRIPTION OF THE INVENTION

The present invention employs a modification to conventional welding practice, whereby the orientation and application of a weld deposit, that forms a structural weld overlay (“SWO”), is re-oriented from a circumferential to an axial orientation during deposition. This re-orientation provides a more favorable condition to prevent weld cracking and shrinkage distortion. The welding method of the present invention also allows two or more weld machines to be used simultaneously, so that two or more welding arcs can be used to deposit filler metal on the same SWO, reducing the overall time required to complete the SWO. The preventative measures afforded by this method result in an overall improvement in structural soundness, corrosion performance and the number of layers required to form an SWO for use on nuclear piping and pressure vessel systems.

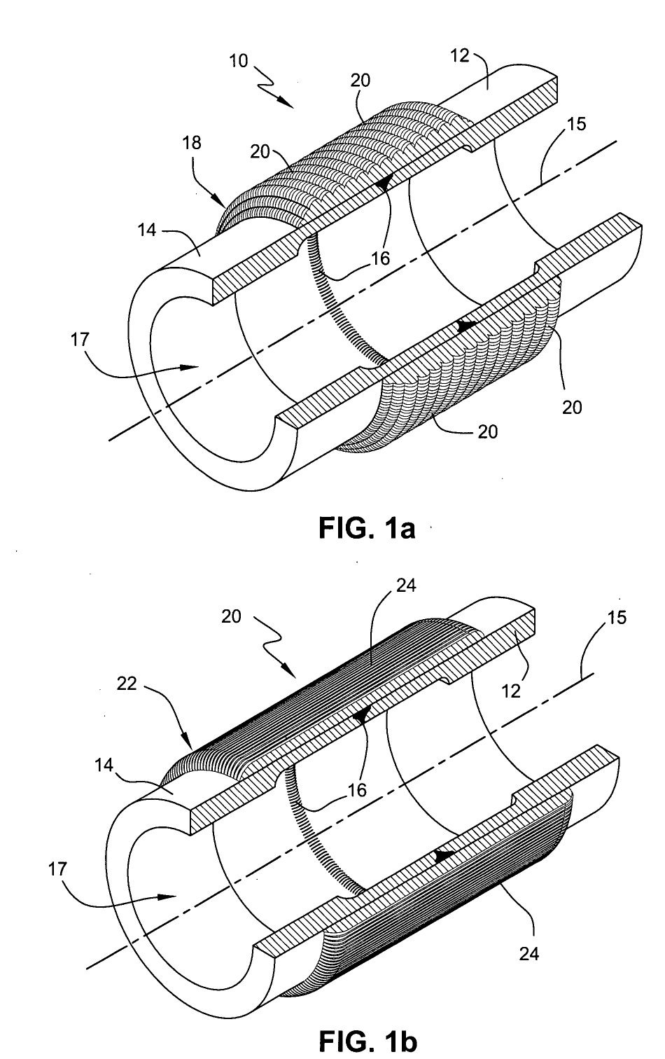

The method of the present invention is ideally suited when performing an SWO on a dissimilar metal weld (“DMW”) between wrought austenitic stainless steel and any other base metals, using high chromium content nickel-based filler metals on piping or pressure vessel systems. The welding method of the present invention is comprised of depositing a weld layer axially, with respect to the piping or system, which is perpendicular to the existing DMW. The difference between a conventional, circumferential weld orientation and the axial weld orientation of the present invention is illustrated in FIGS. 1(a) and 1(b).

FIG. 1(a) shows a conventional, circumferentially oriented weld deposit 10. Two metal pipes 12 and 14 are first joined together by a traditional butt weld 16. Overlaying pipes 12 and 14 at the location of butt weld 16 is a weld overlay 18 applied in a conventional, circumferential orientation. The conventional, circumferential weld overlay 18 includes a plurality of circumferential weld beads 20 that are positioned adjacent to one another, and that are substantially perpendicular to the longitudinal axes 15 of pipes 12 and 14 and substantially parallel to butt weld 16.

FIG. 1(b) shows an axially oriented weld deposit 20 according to the method of the present invention. Here again, metal pipes 12 and 14 are first joined together by a butt weld 16. However, in the arrangement shown in FIG. 1(b), overlaying pipes 12 and 14, again at the location of butt weld 16, is a weld overlay 22 applied in an axial orientation, according to the present invention. The weld overlay 22 includes a plurality of axially oriented weld beads 24 that are positioned adjacent to one another and that are substantially parallel to the longitudinal axis 15 of joined pipes 12 and 14 and substantially perpendicular to butt weld 16.

By orienting the weld deposit 22 axially, so as to be substantially parallel to the longitudinal axis 15 of joined pipes 12 and 14 or, alternatively, a pressure vessel system, a welding configuration is provided that is beneficial, in terms of reduced shrinkage distortion and reduced collapse of the bore 17 of the piping or pressure vessel systems 12/14. This result is beneficial because any fluid, required to flow through the piping or pressure vessel system 12/14, will experience less constricted flow at the point of application of the weld 22, so as to remain closer to design dimensions.

By orienting the weld deposit 22 axially, a tendency to form cracks is also reduced or eliminated. When depositing nickel-based filler metals on austenitic stainless steel, cracking due to welding, is a possibility due to the solidification mode of the weld metal and the inherent dilution of the filler metal deposit by base metal. A weld formed by depositing nickel-base filler metal on to austenitic stainless steel is particularly prone to cracking when the nickel-base filler metal possesses a higher chromium content (e.g., 26-31 weight percent.) Higher chromium contents are known to provide better corrosion resistance, so nickel-base filler metals with higher chromium will continue to be specified when corrosion is a concern and will continue to exhibit cracking behavior when deposited on austenitic stainless steel.

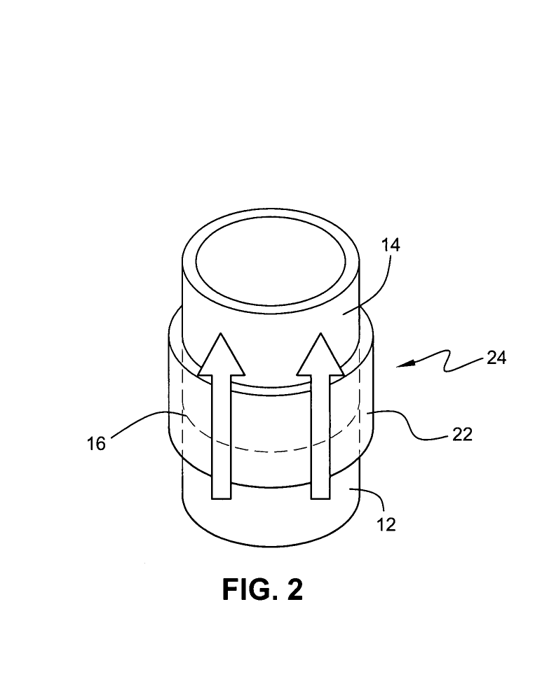

By orienting the weld deposit 22 axially according to the method of the present invention, when welding on a pipe or pressure vessel system with an existing horizontal DMW, the weld deposit 22 can be welded from the bottom pipe 12 to the top pipe 14. FIG. 2 illustrates a horizontal weld joint 16 and a bottom-to-top orientation 24 of the axial weld deposit 22. This bottom to top weld configuration 24 is termed “vertical up” welding and is known to be beneficial to avoid bond defects, termed lack of fusion or bond defects, in the weld. Lack of fusion or lack of bond defects are indicative of weld metal that has not completely melted and coalesced to form a sound metallurgical bond.

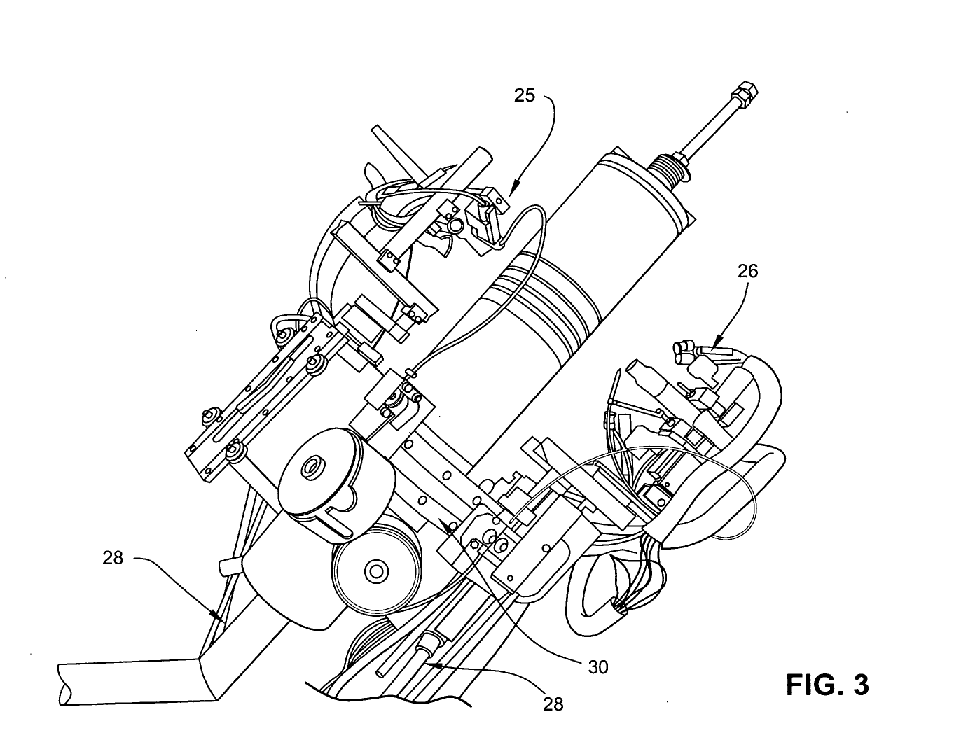

Applying a SWO to a DMW in an operating nuclear power plant must often be accomplished by machine or mechanized welding due to a risk of radiation exposure that would need to be endured by a human working in the vicinity of the area to be welded. Mechanized welding equipment is typically mounted to a track that wraps around the piping or pressure vessel system, and each weld bead is deposited, circumferentially. The welding method of the present invention allows more than one piece of mechanized welding equipment to be mounted to the same track and operated simultaneously. One way to accomplish this is to have each weld machine mounted opposite the other so that neither comes into contact with the other. Each weld machine can be operated independently to achieve one-half of the complete SWO, thereby reducing the time required to complete the weld to roughly one-half. The concept of multiple weld machines 25 and 26 with cable leads 28 mounted on the same track 30 depositing separate weld beads is illustrated in FIG. 3. A subsequent benefit and time savings derives from eliminating the need to “re-wrap” and manage the cables and leads 28. Conventional circumferential welding involves having to manually move the heavy cables and leads 28, since the weld machine is traveling around the pipe or pressure vessel system. By orienting the weld axially, the weld machine 25 is only traveling back and forth, so the cable and leads 28 do not get wrapped around the pipes or pressure vessel system.

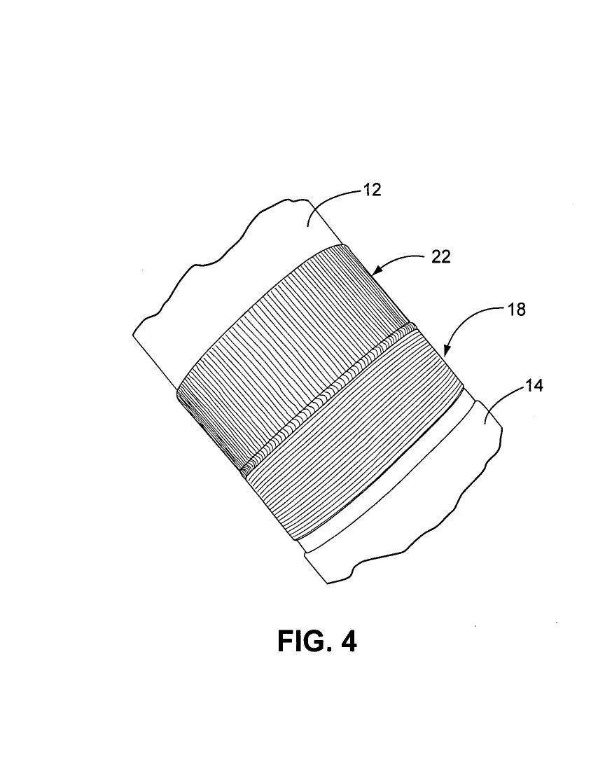

An additional embodiment of the present invention is the use of an axial orientation on only the first or intermittent layers throughout the overall SWO. If cracking, not shrinkage distortion, is the primary concern, then the first layer could be deposited in an axial orientation with subsequent layers deposited circumferentially. As an extension to this embodiment, orientation of the weld deposit could be switched between axial and circumferential orientation in many different combinations to customize the amount of shrinkage that occurs. FIG. 4 illustrates an axially oriented weld deposit 22 on the first layer with a circumferential weld 18 deposited as the second layer.

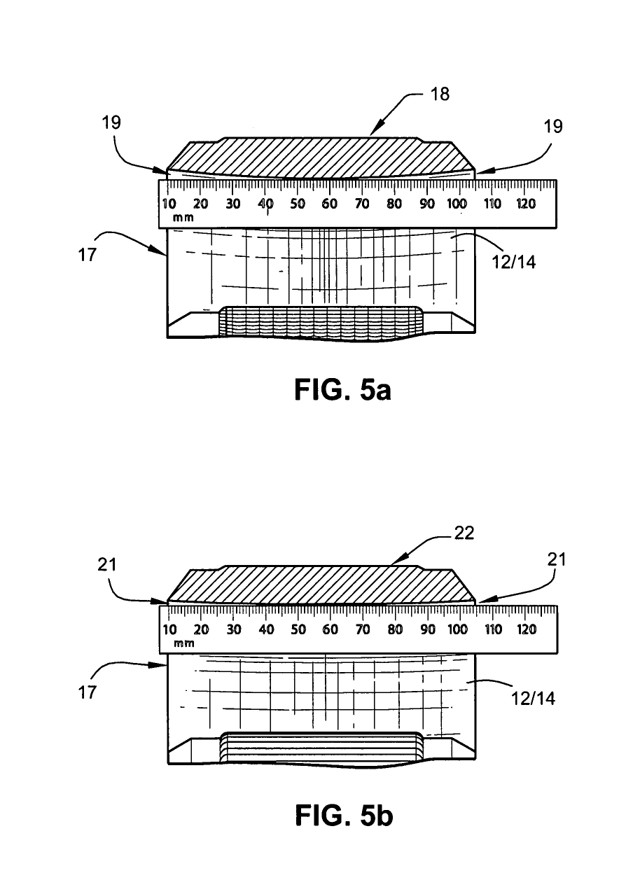

Some test results supporting and differentiating the welding method of the present invention are depicted in FIGS. 5(a) and 5(b), which illustrate the difference in shrinkage driven distortion. FIG. 5(a) illustrates a sectional portion of the inner bore 17 of pipes 12/14 with a conventional circumferential weld deposit 18, resulting in greater shrinkage distortion 19. FIG. 5(b) illustrates a sectional portion of the inner bore 17 of pipes 12/14 with a reduced shrinkage distortion 21, which results by orienting the weld deposit 22 axially and welding according to the method of the present invention.

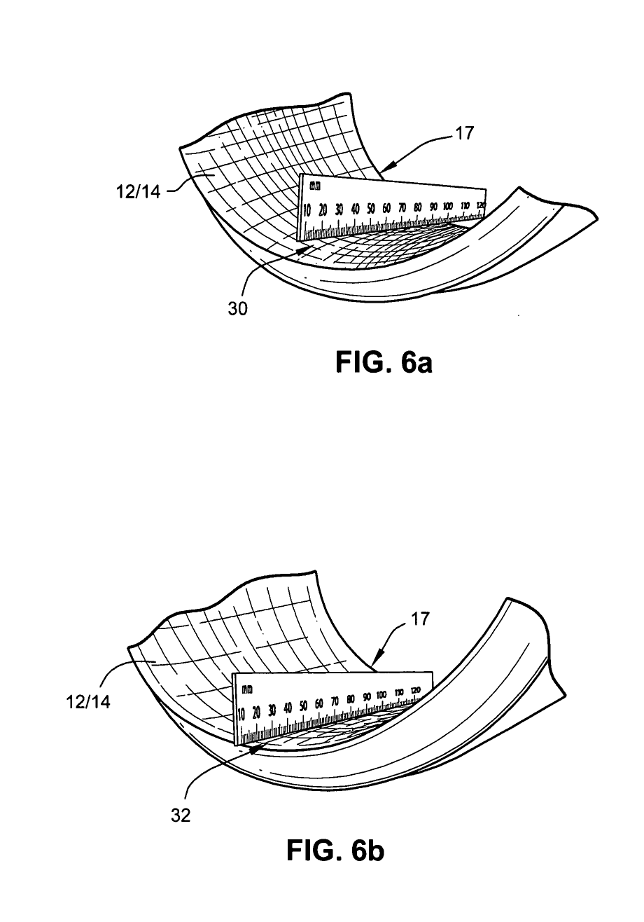

Similarly, FIG. 6(a) and 6(b) illustrate the difference in the bore 17 of two pipes 12 and 14 welded conventionally and according to the present invention. FIG. 6(a) shows a greater reduction 30 in the bore 17 of pipes 12/14 when welding in a circumferential orientation, as opposed to the reduced change 32 in the pipe bore 17 of pipes 12/14 when welding in the axial orientation, as shown in FIG. 6(b).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of depositing a structural weld overlay onto a dissimilar metal weld between first and second piping components or a pressure vessel and an attachment comprising applying at least one layer of a weld deposit onto the first and second piping compartments or the pressure vessel and attachment with an orientation that is substantially perpendicular to the dissimilar metal weld.

2. The method of claim 1, further comprising applying at least one additional layer of weld deposit over the previously applied at least one weld deposit with an orientation that is substantially perpendicular to the dissimilar metal weld's orientation.

3. The method of claim 1, further comprising applying at least one additional layer of weld deposit over the previously applied at least one weld deposit with an orientation that is substantially parallel to the dissimilar metal weld's orientation.

4. The method of claim 1 wherein deposit filler metal is deposited on the structural weld overlay simultaneously by at least two weld machines.

5. A method of applying a weld that is a structural weld overlay to first and second pipes made from dissimilar metals and joined by a butt weld comprising applying over the butt weld a plurality of axially oriented weld beads positioned adjacent to one another so as to form the structural weld overlay.

6. The method of claim 5 further comprising applying over the plurality of axially oriented weld beads a plurality of circumferentially oriented weld beads positioned adjacent to one another so as to form a second structural weld overlay that is oriented substantially perpendicular to previously applied structural weld overlay.

7. The method of claim 5 wherein deposit filler metal is deposited on the structural weld overlay simultaneously by at least two weld machines.

8. A method of forming a structural weld overlay or a dissimilar metal weld between two dissimilar metal components comprising depositing over the dissimilar metal weld and on the components with an orientation that is substantially perpendicular to the dissimilar metal weld a plurality of beads of filler metal positioned adjacent to one another to form the structural weld overlay, whereby weld cracking and shrinkage distortion are reduced.

9. The method of claim 8 wherein the dissimilar metal weld is substantially circumferentially oriented.

10. The method of claim 9 wherein the structural weld overlay is substantially axially oriented.

11. The method of claim 8 wherein the two dissimilar metal components are pipes.

12. The method of claim 8 wherein the two dissimilar metal components are pressure vessels.

13. The method of claim 8 wherein one of the two dissimilar metal components is a pressure vessel and the other component is an attachment to the pressure vessel.

14. The method of claim 8 wherein one of the two dissimilar metal components is wrought austenitic stainless steel and the other component is any other base metal.

15. The method of claim 8 wherein the filler metal is a nickel-based metal with high chromium content.

16. The method of claim 8 further comprising applying over the plurality of perpendicularly oriented beads a plurality of beads or filler metal being positioned adjacent to one another and having an orientation that is substantially parallel to the dissimilar metal weld so as to form a second structural overlay over the previously formed structural overlay.
